(19) United States
(12) Patent Application Publication
(10) Pub. No.: US 2022/0091878 A1
(43) Pub. Date: Mar. 24, 2022

(54) Transaction Replacing Method, Transaction Queuing Method, Device, and Storage Medium

(71) Applicant: JIANGSU FUZAMEI TECHNOLOGY CO., LTD., Suzhou (CN)

(72) Inventors: Sijin WU, Suzhou (CN); Dehai CHEN, Suzhou (CN); Zhiwen WANG, Suzhou (CN)

(21) Appl. No.: 17/424,884

(22) PCT Filed: Jan. 23, 2020
(86) PCT No.: PCT/CN2020/073984

§ 371 Date: Jul. 22, 2021

(30) Foreign Application Priority Data
Jan. 28, 2019 (CN) 201910077658.5

(51) Int. Cl. G06F 9/46; G06F 9/50

(52) U.S. Cl. CPC G06F 9/467; G06F 9/505; G06F 9/5016

(57) ABSTRACT

A transaction replacing method, a transaction queuing method, a device, and a storage medium. The method comprises: receiving a first transaction to be stored into a memory pool and transmitted by a client and determining, by means of whether first predecessor transaction information of the first transaction is null, whether the first transaction is a first-type transaction for replacing a predecessor transaction or a second-type transaction not for replacing a predecessor transaction (S12); if the first transaction is a first-type transaction, then querying whether the predecessor transaction of the first transaction is present in the memory pool on the basis of the first predecessor transaction information (S14); and if yes, then deleting the predecessor transaction from the memory pool and storing the first transaction into the memory pool (S16). The method allows, when an unpacked predecessor transaction is present in the memory pool, a node to receive a new transaction transmitted by a user to replace the predecessor transaction, thus providing the user with great user experience.

### BACKGROUND OF THE PRESENT INVENTION

### Field of Invention

The present invention relates to the technical field of blockchain, and in particular, to a transaction replacing method, transaction queuing method, device, and storage medium.

### Description of Related Arts

In the current blockchain technology, after the user sends an error transaction to the blockchain network, the transaction content cannot be changed, wherein the transaction content includes the receiver address of the transaction, the transfer amount of the transaction, the miner's fee of the transaction packaging, and etc. The sent transaction can only wait to be executed, or be cancelled after a period of time due to insufficient miner's fee. As a result, the interests of the user cannot be protected. Besides, once the user submits the transaction, the queuing information of the submitted transaction cannot be known, and the demand of the user to query the transaction queuing condition cannot be satisfied.

### SUMMARY OF THE PRESENT INVENTION

In accordance of the defects or drawbacks of the conventional technologies, the present invention aims to provide a transaction replacing method, transaction queuing method, device, and storage medium, which allow replaceable transaction contents and inquiring transaction queuing states.

In a first aspect, the present invention provides a transaction replacing method, comprising:

receiving a first transaction to be stored into a memory pool and transmitted by a client and determining, by means of whether first predecessor transaction information of the first transaction is null, whether the first transaction is a first-type transaction for replacing a predecessor transaction or a second-type transaction not for replacing a predecessor transaction:

if the first transaction is a first-type transaction, then querying whether the predecessor transaction of the first transaction is present in the memory pool on the basis of the first predecessor transaction information:

if yes, deleting the first predecessor transaction from the memory pool and saving the first transaction into the memory pool.

In a second aspect, the present invention provides a transaction queuing method, comprising:

generating queue information according to the price indexes of the transactions in the memory pool in order to sequence the transactions, wherein the queue information is utilized for packaging the transactions in order;

Here, the price index is positively correlated to the miner's fee, while the transaction is the transaction in the memory pool after the node executes the transaction replacing method.

In a third aspect, the present invention provides a transaction replacing method, comprising:

sending a first transaction with a first predecessor transaction information to a first node, so as for the first node to receive the first transaction and determine, by means of whether first predecessor transaction information of the first transaction is null, whether the first transaction is a first-type transaction for replacing a predecessor transaction or a second-type transaction not for replacing a predecessor transaction:

if the first transaction is a first-type transaction, then querying whether the predecessor transaction of the first transaction is present in the memory pool on the basis of the first predecessor transaction information:

if yes, deleting the first predecessor transaction from the memory pool and saving the first transaction into the memory pool.

In a fourth aspect, the present invention also provides a device, which includes one or more processors and a storage, wherein the storage includes commands executable by the one or more processors to allow the one or more processors to perform transaction replacing methods and transaction queuing methods provided in accordance with embodiments of the present invention.

In a fifth aspect, the present invention also provides a storage medium with computer program stored therein so as for allowing a computer to perform transaction replacing methods and transaction queuing methods provided in accordance with the embodiments of the present invention.

Transaction replacing methods, transaction queuing methods, devices, and storage media provided by the embodiments of the present invention utilize processes of receiving a first transaction to be stored into a memory pool and transmitted by a client and determining, by means of whether first predecessor transaction information of the first transaction is null, whether the first transaction is a first-type transaction for replacing a predecessor transaction or a second-type transaction not for replacing a predecessor transaction; if the first transaction is a first-type transaction, then querying whether the predecessor transaction of the first transaction is present in the memory pool on the basis of the first predecessor transaction information; and if yes, then deleting the predecessor transaction from the memory pool and storing the first transaction into the memory pool. When an unpacked predecessor transaction is present in the memory pool, a node to receive a new transaction transmitted by a user to replace the predecessor transaction, thus providing the user with great user experience.

The transaction replacing method, transaction queuing method, device, and storage medium provided by some embodiment of the present invention further utilizes the method that judges and determines if the first address sending the first transaction and the second address sending the first predecessor transaction are the same: if yes, it deletes the first predecessor transaction from the memory pool and saves the first transaction into the memory pool, so as to avoid different users from maliciously sending a first transaction to replace a first predecessor transaction that does not belong to him/her, such that the security of the blockchain system can be increased and the user experience can further be enhanced.

The transaction replacing method, transaction queuing method, device, and storage medium provided by some embodiment of the present invention further utilizes the method that judges and determines if the hash value of the first transaction content and the hash value of the second transaction content are the same: if yes, it deletes the first predecessor transaction from the memory pool and saves the first transaction into the memory pool, such that different transaction contents cannot replace each other, which prevent the user from sending a wrong first transaction to replace a correct first predecessor transaction after s/he has sent the correct first predecessor transaction, so that the user experience can further be improved.

The transaction replacing method, transaction queuing method, device, and storage medium provided by some embodiment of the present invention further utilizes the method judges and determines if the price index of the first transaction is greater than the price index of the first predecessor transaction: if yes, it deletes the first predecessor transaction from the memory pool and saves the first transaction into the memory pool, so as to let the miner's fee consumed by the first transaction necessarily higher than the miner's fee consumed by the first predecessor transaction, which ensures that when the first transaction sent by the user is utilized to replace the first predecessor transaction, the first transaction can surely enter the memory pool, which further improves the user experience.

The transaction replacing method, transaction queuing method, device, and storage medium provided by some embodiment of the present invention further generates queue information according to the price indexes of the transactions in the memory pool in order to sequence the transactions, wherein the queue information is utilized for packaging the transactions in order, wherein the price index and the miner's fee are positively correlated, wherein the method having the transaction be the transaction in the memory pool after the node executed the transaction replacing method achieves a queuing mechanism to allow the transaction(s) in jam to be processed timely, which enhances the user experience.

The transaction replacing method, transaction queuing method, device, and storage medium, according to some embodiments of the present invention, further have the queue information include queue index disposed therein and the node of the blockchain have a first port disposed thereon, wherein the first port is utilized for client visiting so as to acquire the queue index of the transaction in the queue, which allows the client to check the queuing state of the transaction(s) and therefore enhance the user experience.

### BRIEF DESCRIPTION OF THE DRAWINGS

Other features, objects, and advantages of the present application will become more obvious through referring to the detail descriptions of the embodiments that are illustrated in, but not limited by the following figures.

FIG. 1 is a flow diagram of a transaction replacing method according to an embodiment of the present invention.

FIG. 2 is a flow diagram of a step S16 of the method of FIG. 1 according to a preferred embodiment.

FIG. 3 is a flow diagram of a step S16 of the method of FIG. 1 according to a preferred embodiment.

FIG. 4 is a flow diagram of a step S16 of the method of FIG. 1 according to a preferred embodiment.

FIG. 5 is a flow diagram of a transaction queuing method according to an embodiment of the present invention.

FIG. 6 is a flow diagram of a transaction replacing method according to an embodiment of the present invention.

FIG. 7 is a composition diagram of a device according to an embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

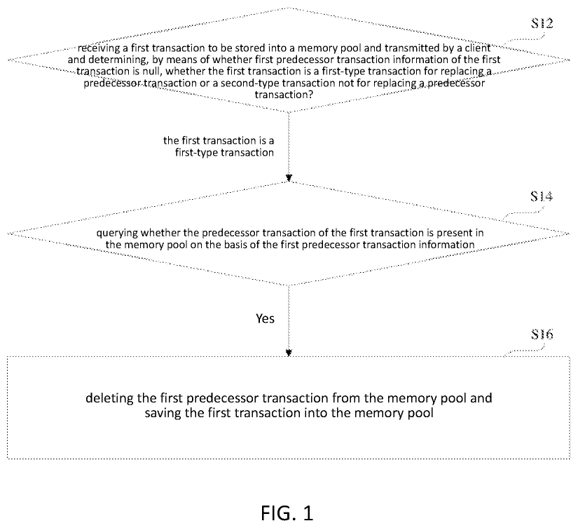

FIG. 1 is a flow diagram of a transaction replacing method according to an embodiment of the present invention. Referring to FIG. 1, according to the present embodiment, a transaction replacing method provided by the present invention comprises:

S12: receiving a first transaction to be stored into a memory pool and transmitted by a client and determining, by means of whether first predecessor transaction information of the first transaction is null, whether the first transaction is a first-type transaction for replacing a predecessor transaction or a second-type transaction not for replacing a predecessor transaction:

if the first transaction is a first-type transaction, then executing the step S14: querying whether the predecessor transaction of the first transaction is present in the memory pool on the basis of the first predecessor transaction information:

if yes, executing the step S16 to delete the first predecessor transaction from the memory pool and save the first transaction into the memory pool.

Specifically, when the first predecessor transaction information is not null, the first predecessor transaction information is the transaction hash of the predecessor transaction. Here, an example is given that when there are 100 transactions, tx_1˜tx_100, in the current memory pool and when a node A of the blockchain receives a transaction, tx_101, sent by a user A, wherein the first predecessor information of tx_101 is hash(tx_80).

In the step S12, the node A receives a tx_101 transmitted by user A and to be stored into a memory pool and determines, by means of whether the first predecessor transaction information of the tx_101 is null, whether the tx_101 is a first-type transaction for replacing a predecessor transaction or a second-type transaction not for replacing a predecessor transaction:

Because the first predecessor information of the tx_101 is hash(tx_80), therefore tx_101 is a first-type transaction, then the step S14 will be executed to query whether the predecessor transaction tx_80 of the tx_101 is present in the memory pool on the basis of the first predecessor transaction information hash(tx_80);

because there are 100 transactions tx_1˜tx_100, which include tx_80, in the memory pool, therefore executing the step S16 to delete the tx_80 from the memory pool and save the tx_101 into the memory pool.

According to the above embodiment, the method allows, when an unpacked predecessor transaction is present in the memory pool, a node to receive a new transaction transmitted by a user to replace the predecessor transaction, thus providing the user with great user experience.

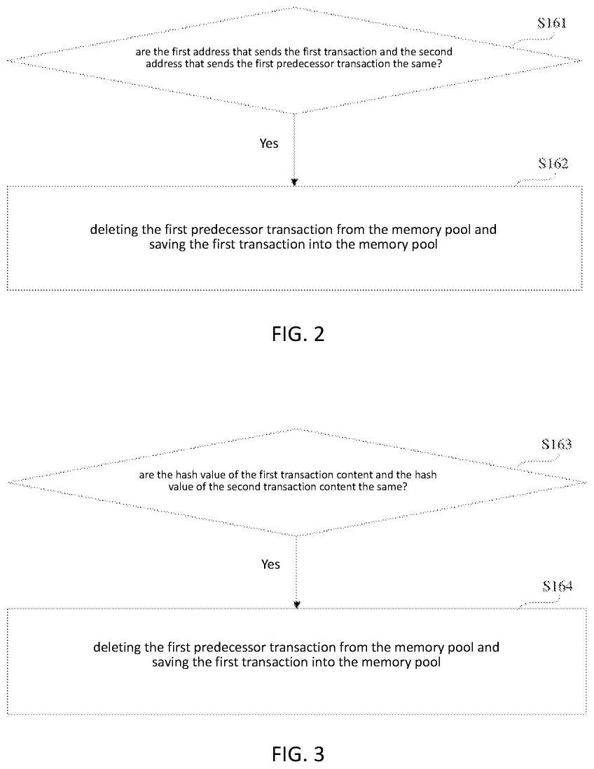

FIG. 2 is a flow diagram of a step S16 of the method of FIG. 1 according to a preferred embodiment. Referring to FIG. 2, according to another preferred embodiment, the step S16 comprises:

S161: determining if the first address that sends the first transaction and the second address that sends the first predecessor transaction are the same:

if yes, executing S162 to delete the first predecessor transaction from the memory pool and save the first transaction into the memory pool.

Specifically, it is similar with the above example that when the first predecessor transaction information is not null, the first predecessor transaction information is the transaction hash of the predecessor transaction and an example is given that when there are 100 transactions, tx_1˜tx_79, tx_81˜tx_101, in the current memory pool, and a node of the blockchain A receives a transaction tx_102 sent from a user A, wherein the first predecessor information of tx_102 is hash(tx_81), assuming that the first address sending the tx_102 is the same to the second address sending the tx_81.

In the step S161, the node A judges if the first address that sends the first transaction and the second address that sends the first predecessor transaction are the same:

because the first address that sends tx_102 and the second address that sends the tx_81 are the same, executing the step S162 to delete the tx_81 from the memory pool and save the tx_102 into the memory pool.

The above embodiment prevents a different client from maliciously sending a first transaction to replace a first predecessor transaction that does not belong to him/her, so as to enhance the security of the blockchain system and further improve the user experience.

FIG. 3 is a flow diagram of a step S16 of the method of FIG. 1 according to a preferred embodiment. Referring to FIG. 3, according to another preferred embodiment, the step S16 comprises:

S163: determining if the hash value of the first transaction content and the hash value of the second transaction content are the same:

if yes, executing the step S164 to delete the first predecessor transaction from the memory pool and save the first transaction into the memory pool.

Here, the first transaction content is generated according to certain information of the first transaction besides of the consumed miner's fee and the first predecessor transaction information, wherein the second transaction content is generated according to certain information of the first predecessor transaction besides of the consumed miner's fee and the predecessor transaction information of the first predecessor transaction.

Specifically, also when the first predecessor transaction information is not null, the first predecessor transaction information is the transaction hash of the predecessor transaction. Here, an example is given that when there are 100 transactions, tx_1˜tx_79, tx_82˜tx_102, in the current memory pool and when a node A of the blockchain receives a transaction, tx_103, sent by a user A, wherein the first predecessor information of tx_103 is hash(tx_82). Assuming that both tx_103 and tx_82 are transaction of transferring, the first transaction content will be generated based on the transaction initiator addr(A) of the tx_103, the transaction receiver addr(B) of the tx_103, and the transaction amount M of the tx_103, wherein the second transaction content will be generated based on the transaction initiator addr(A′) of the tx_82, the transaction receiver addr(B′) of the tx_82, and the transaction amount M′ of the tx_82, wherein addr(A) and addr(A′) are the same, addr(B) and addr(B′) are the same, and M and M′ are the same.

In the step S163, the node A judges if the hash value of the first transaction content and the hash value of the second transaction content are the same:

because addr(A) and addr(A′) are the same, addr(B) and addr(B′) are the same, and M and M′ are the same, concluding that the first transaction content and the second transaction content are the same, therefore executing the step S164: deleting the tx_82 from the memory pool and saving the tx_103 into the memory pool.

The above embodiment prevents transactions of different transaction contents from being replaced with each other, so as to avoid the user from sending a wrong first transaction to replace a correct first predecessor transaction after s/he has sent the correct first predecessor transaction, so that the user experience can be improved.

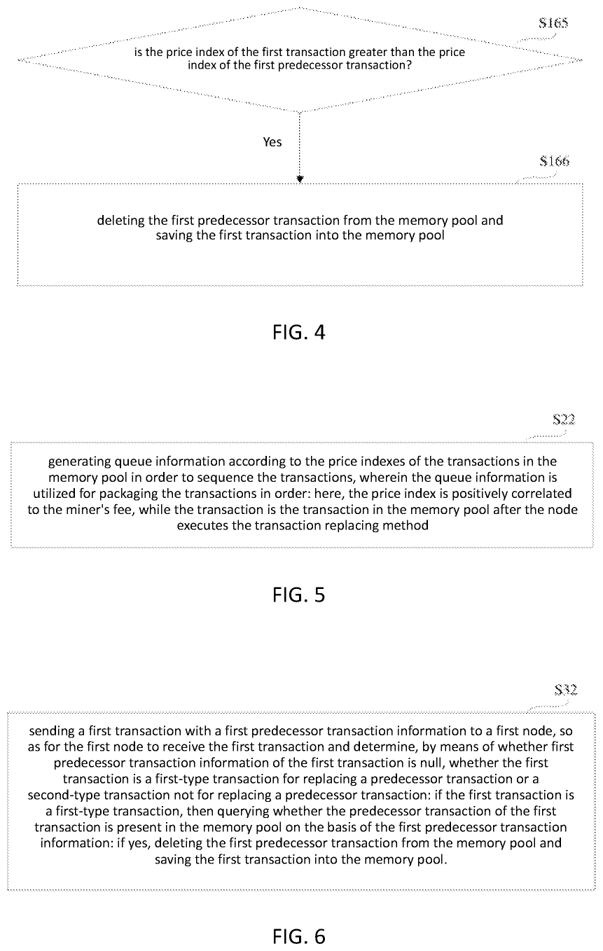

FIG. 4 is a flow diagram of a step S16 of the method of FIG. 1 according to a preferred embodiment. Referring to FIG. 4, according to another preferred embodiment, the step S16 comprises:

S165: determining if the price index of the first transaction is greater than the price index of the first predecessor transaction:

if yes, executing the step S166 to delete the first predecessor transaction from the memory pool and save the first transaction into the memory pool.

Here, the price index and the miner's fee are positively correlated.

Specifically, it is similar with the above example that when the first predecessor transaction information is not null, the first predecessor transaction information is the transaction hash of the predecessor transaction and an example is given that when there are 100 transactions, tx_1˜tx_79, tx_83˜tx_103, in the current memory pool, and a node of the blockchain A receives a transaction tx_104 sent from a user A, wherein the first predecessor information of tx_104 is hash(tx_83). Because the price index and the miner's fee are positively correlated, assuming that the calculation method of the price index Q is Q=fee, wherein the fee is the miner's fee, the price index Q_104 of tx_104 is fee 104, the price index Q_83 of tx_83 is fee_83, and fee 104 is greater than fee_83.

In the step S165, node A judges and determines if the price index of the tx_104 is greater than the price index of the tx_83:

if the fee 104 is greater than the fee_83, executing the step S166: deleting the tx_83 from the memory pool and saving the tx_104 into the memory pool.

According to the present embodiment, the computing mode of the price index has been illustrated based on the example that the computing mode of the price index is Q=fee. According to more embodiments, the computing mode of the price index may also be, based on actual needs, configured into other computing modes in the art. For instance, Q=fee*C, whereas C is a first constant, and etc. As long as the price index is positively correlated to the miner's fee, it can also achieve the same technical results.

The above embodiment lets the miner's fee consumed by the first transaction necessarily higher than the miner's fee consumed by the first predecessor transaction, so as to ensure that when the first transaction sent by the user is utilized to replace the first predecessor transaction, the first transaction can surely enter the memory pool, which further improves the user experience.

FIG. 5 is a flow diagram of a transaction queuing method according to an embodiment of the present invention. Referring to FIG. 5, according to the present embodiment, a transaction queuing method provided by the present invention comprises:

S22: generating queue information according to the price indexes of the transactions in the memory pool in order to sequence the transactions, wherein the queue information is utilized for packaging the transactions in order;

Here, the price index is positively correlated to the miner's fee, while the transaction is the transaction in the memory pool after the node executes the transaction replacing method.

Specifically, an example is given that the current memory pool has 100 transactions, tx_1˜tx_79, tx_84˜tx_104, tx_1˜tx_79, tx_84˜tx_104, therein after the node A has executed the transaction replacing method and the calculation method of the price index Q is Q=fee, wherein the fee is the miner's fee;

the price index Q_1 of the tx_1 is fee_1; for example, if fee_1=0.01, then Q_1=fee_1=0.01;

the price index Q_2 of the tx_2 is fee_2; . . . ; the price index Q_104 of the tx_104 is fee 104;

In the step S22, orderly generating queue information [tx_33, tx_104˜tx_85, tx22] according to the price indexes Q_1˜Q_79, Q_84˜Q_104 of the transactions, tx_1˜tx_79, tx_84˜tx_104, in the memory pool. The queue information is utilized for packaging the transactions in order.

The above embodiment implements and provides a queuing mechanism allowing transactions to be processed timely when jam, which enhances the user experience.

According to a preferred embodiment, the calculation method of the price index is: Q=fee*C/B.

Here, Q is the price index of the transaction, fee is the miner's fee of the transaction, C is a first constant, and B is the number of bytes of the transaction.

According to more embodiments, different computing modes of the art, for example, Q=fee\hat{ }2*C/B, Q=fee*C/B\hat{ }2, and etc., may also be utilized and disposed based on the actual needs for acquiring the price index. The same technical results may still be achieved as long as the price index is positively correlated to the miner's fee and/or the price index is negatively correlated to the data quantity.

The embodiment achieves that the user offers a higher miner's fee or a lower data quantity for the transaction in order for the transaction to be timely processed when jam, which enhances the user experience.

According to a preferred embodiment, the queue information includes queue index.

According to a preferred embodiment, the node of the blockchain has a first port disposed thereon, wherein the first port is utilized for a client's visit in order for acquiring the queue index of the transaction in the queue. The embodiment allows the client to inquire and check the transaction queuing state, which further enhances the user experience.

FIG. 6 is a flow diagram of a transaction replacing method according to an embodiment of the present invention. Referring to FIG. 6, according to the present embodiment, a transaction replacing method provided by the present invention comprises:

S32: sending a first transaction with a first predecessor transaction information to a first node, so as for the first node to receive the first transaction and determine, by means of whether first predecessor transaction information of the first transaction is null, whether the first transaction is a first-type transaction for replacing a predecessor transaction or a second-type transaction not for replacing a predecessor transaction:

if the first transaction is a first-type transaction, then querying whether the predecessor transaction of the first transaction is present in the memory pool on the basis of the first predecessor transaction information:

if yes, deleting the first predecessor transaction from the memory pool and saving the first transaction into the memory pool.

Specifically, when the first predecessor transaction information is not null, the first predecessor transaction information is the transaction hash of the predecessor transaction. Here, an example is given that when there are 100 transactions, tx_1˜tx_79, tx_84˜tx_104, in the current memory pool, a user A sends a transaction, tx_105, to a node of the blockchain A, wherein the first predecessor information of tx_105 is hash(tx_84).

In the step S32, the user A sends a first transaction tx_105 with a first predecessor transaction information to a node A, so as for the node A to receive the tx_105 and determine, by means of whether the first predecessor transaction information of the tx_105 is null, whether the tx_105 is a first-type transaction for replacing a predecessor transaction or a second-type transaction not for replacing a predecessor transaction:

because the first predecessor transaction information of the tx_105 is hash(tx_80), therefore, according to the first predecessor transaction information hash(tx_84), checking if the predecessor transaction of tx_105 is in the memory pool:

because there are 100 transactions tx_1˜tx_79, tx_84˜tx_104, which include tx_84, in the memory pool, therefore deleting the tx_84 from the memory pool and saving the tx_105 into the memory pool.

According to the above embodiment, when an unpacked predecessor transaction is in the memory pool, the user may send a node a new transaction for replacing the predecessor transaction, which provides the user a great user experience.

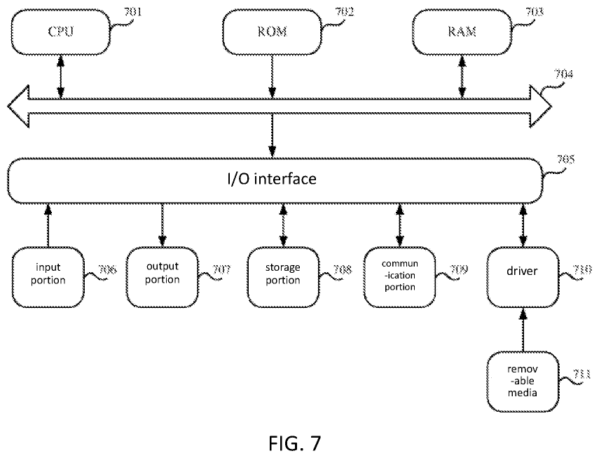

FIG. 7 is a composition diagram of a device according to an embodiment of the present invention.

Referring to FIG. 7, in another aspect, the present application also provides a device 700, which includes one or more central processing units (CPUs) 701 that can perform various suitable actions and processes in accordance with a program stored in a read-only memory (ROM) 702 or a program loaded into a random access memory (RAM) 703 from a storage portion 708. Various programs and data required for the operation of the device 700 are also stored in the RAM 703. The CPU 701, the ROM 702, and the RAM 703 are connected to each other via a bus 704. An input/output (I/O) interface 705 is also connected to the bus 704.

The following components are connected to the I/O interface 705: an input portion 706 including a keyboard, a mouse, and etc.; an output portion 707 including a cathode ray tube (CRT), a liquid crystal display (LCD), and etc., and a speaker and etc.; a storage portion 708 including a hard disk or the like; and a communication portion 709 including a network interface card, such as a LAN card, a modem, and etc. The communication portion 709 performs communication process via a network, such as the Internet. A driver 710 is also connected to the I/O interface 705 based on the needs. A removable media 711, such as magnetic disks, optical disks, magneto-optical disks, semiconductor memories, and etc., is mounted on the driver 710 based on the needs so that the computer programs read therefrom can be installed into the storage portion 708 as needed.

In particular, according to the embodiments of the present invention, the transaction replacing methods and transaction queuing methods described in any of the above embodiments may be implemented as the computer program. For example, an embodiment of the present invention may provide a computer program product, which includes a computer program tangibly loaded on a machine-readable medium containing program code for performing transaction replacing methods and transaction queuing methods. According to such embodiment, the computer program may be downloaded and installed from the network through the communication portion 709 and/or installed from the removable medium 711.

As yet another aspect, the present application also provides a computer-readable storage medium, which may be a computer-readable storage medium included in a device of the above-described embodiments, or a computer-readable storage medium that may be provided separately, without being assembled in the device. The computer-readable storage medium stores one or more programs that are utilized by one or more processors to perform transaction replacing methods and transaction queuing methods disclosed in the present application.

The flow chart and block diagrams in the figures illustrate the constructions, functionality, and operation of possible implementations of the systems, methods, and computer program products according to various embodiments of the present invention. In this regard, each block in the flow chart or block diagrams may represent a module, segment, or portion of code, which includes one or more executable instructions for implementing the specified logical function (s). It should also be noted that, in some alternative implementations, the functions illustrated in the block may occur out of the order illustrated in the figures. For example, two blocks represented in succession may, in fact, be executed substantially concurrently, or the blocks may sometimes be executed in the reverse order, depending upon the functionality involved. It will also be noted that each block of the block diagrams and/or flow chart illustration, and combinations of the blocks in the block diagrams and/or flow chart illustration, may be implemented by special purpose hardware-based systems that perform the specified functions or acts, or combinations of special purpose hardware and computer instructions.

The units or modules described in the embodiments of the present application may be implemented in a software manner, or may be implemented in a hardware manner. The described units or modules may also be provided in a processor, for example, each of which may be a software program disposed in a computer or a mobile smart device or a separately configured hardware device. The names of these units or modules, in some cases, do not constitute a definition of the unit or module itself.

The above description is merely preferred embodiment(s) of the present application and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

1-11. (canceled)

12. A transaction replacing method, suitable for node of a blockchain, comprising:
receiving a first transaction to be stored into a memory pool and transmitted by a client; and
determining, by means of whether a first predecessor transaction information of the first transaction is null, whether the first transaction is a first-type transaction for replacing a predecessor transaction or a second-type transaction not for replacing a predecessor transaction:
if the first transaction is a first-type transaction, then querying whether the predecessor transaction of the first transaction is present in the memory pool on the basis of the first predecessor transaction information:
if yes, deleting the first predecessor transaction from the memory pool and saving the first transaction into the memory pool, wherein the first predecessor transaction information is the transaction hash of the predecessor transaction of the first transaction.

13. The transaction replacing method, as recited in claim 12, further comprising:
determining if the first address that sends the first transaction and the second address that sends the first predecessor transaction are the same:
if yes, deleting the first predecessor transaction from the memory pool and saving the first transaction into the memory pool.

14. The transaction replacing method, as recited in claim 12, further comprising:
determining if the hash value of the first transaction content and the hash value of the second transaction content are the same:
if yes, deleting the first predecessor transaction from the memory pool and saving the first transaction into the memory pool, wherein the first transaction content is generated according to certain information of the first transaction besides of the consumed a fee of a miner and the first predecessor transaction information, wherein the second transaction content is generated according to certain information of the first predecessor transaction besides of the consumed the fee of the miner and the predecessor transaction information of the first predecessor transaction.

15. The transaction replacing method, as recited in claim 13, further comprising:
determining if the hash value of the first transaction content and the hash value of the second transaction content are the same:
if yes, deleting the first predecessor transaction from the memory pool and saving the first transaction into the memory pool, wherein the first transaction content is generated according to certain information of the first transaction besides of the consumed the fee of the miner and the first predecessor transaction information, wherein the second transaction content is generated according to certain information of the first predecessor transaction besides of the consumed the fee of the miner and the predecessor transaction information of the first predecessor transaction.

16. The transaction replacing method, as recited in claim 12, further comprising:
determining if the price index of the first transaction is greater than the price index of the first predecessor transaction:
if yes, deleting the first predecessor transaction from the memory pool and saving the first transaction into the memory pool, wherein the price index and a fee of a miner are positively correlated.

17. The transaction replacing method, as recited in claim 15, further comprising:
determining if the price index of the first transaction is greater than the price index of the first predecessor transaction:
if yes, deleting the first predecessor transaction from the memory pool and saving the first transaction into the memory pool, wherein the price index and the fee of the miner are positively correlated.

18. A transaction queuing method, suitable for node of a blockchain, comprising:
generating a queue information according to price indexes of transactions in a memory pool in order to sequence the transactions, wherein the queue information is utilized for packaging the transactions in order, wherein each of the price indexes is positively correlated to a fee of a miner, wherein each of the transactions is a transaction in the memory pool after the node executes a transaction replacing method which comprises:
receiving a first transaction to be stored into the memory pool and transmitted by a client; and
determining, by means of whether a first predecessor transaction information of the first transaction is null, whether the first transaction is a first-type transaction for replacing a predecessor transaction or a second-type transaction not for replacing a predecessor transaction:
if the first transaction is a first-type transaction, then querying whether the predecessor transaction of the first transaction is present in the memory pool on the basis of the first predecessor transaction information:
if yes, deleting the first predecessor transaction from the memory pool and saving the first transaction into the memory pool, wherein the first predecessor transaction information is the transaction hash of the predecessor transaction of the first transaction.

19. The transaction queuing method, as recited in claim 18, wherein the transaction replacing method further comprises:
determining if the first address that sends the first transaction and the second address that sends the first predecessor transaction are the same:
if yes, deleting the first predecessor transaction from the memory pool and saving the first transaction into the memory pool.

20. The transaction queuing method, as recited in claim 18, wherein the transaction replacing method further comprises:
determining if the hash value of the first transaction content and the hash value of the second transaction content are the same:
if yes, deleting the first predecessor transaction from the memory pool and saving the first transaction into the memory pool, wherein the first transaction content is generated according to certain information of the first transaction besides of the consumed the fee of the miner and the first predecessor transaction information, wherein the second transaction content is generated according to certain information of the first predecessor transaction besides of the consumed a fee of a miner and the predecessor transaction information of the first predecessor transaction.

21. The transaction queuing method, as recited in claim 19, wherein the transaction replacing method further comprises:
determining if the hash value of the first transaction content and the hash value of the second transaction content are the same:
if yes, deleting the first predecessor transaction from the memory pool and saving the first transaction into the memory pool, wherein the first transaction content is generated according to certain information of the first transaction besides of the consumed the fee of the miner and the first predecessor transaction information, wherein the second transaction content is generated according to certain information of the first predecessor transaction besides of the consumed a fee of a miner and the predecessor transaction information of the first predecessor transaction.

22. The transaction queuing method, as recited in claim 18, wherein the transaction replacing method further comprises:
determining if the price index of the first transaction is greater than the price index of the first predecessor transaction:
if yes, deleting the first predecessor transaction from the memory pool and saving the first transaction into the memory pool, wherein the price index and the fee of the miner are positively correlated.

23. The transaction queuing method, as recited in claim 21, wherein the transaction replacing method further comprises:
determining if the price index of the first transaction is greater than the price index of the first predecessor transaction:
if yes, deleting the first predecessor transaction from the memory pool and saving the first transaction into the memory pool, wherein the price index and the fee of the miner are positively correlated.

24. The transaction queuing method, as recited in claim 18, wherein the queue information includes queue index.

25. The transaction queuing method, as recited in claim 23, wherein the queue information includes queue index.

26. The transaction queuing method, as recited in claim 18, the node of the blockchain has a first port disposed thereon, wherein the first port is utilized for a visit of the client in order for acquiring the queue index of the transaction in the queue.

27. The transaction queuing method, as recited in claim 23, the node of the blockchain has a first port disposed thereon, wherein the first port is utilized for a visit of the client in order for acquiring the queue index of the transaction in the queue.

28. A transaction replacing method, adapted for a client, comprising:
sending a first transaction with a first predecessor transaction information to a first blockchain node, so as for the first blockchain node to receive the first transaction; and
determining, by means of whether the first predecessor transaction information of the first transaction is null, whether the first transaction is a first-type transaction for replacing a predecessor transaction or a second-type transaction not for replacing a predecessor transaction:
if the first transaction is a first-type transaction, then querying whether the predecessor transaction of the first transaction is present in a memory pool on a basis of the first predecessor transaction information:
if yes, deleting the first predecessor transaction from the memory pool and saving the first transaction into the memory pool, wherein the first predecessor transaction information is a transaction hash of the predecessor transaction of the first transaction.
